(19) United States
(12) Patent Application Publication
(10) Pub. No.: US 2003/0074447 A1
(43) Pub. Date: Apr. 17, 2003

(54) Intuitive mapping between explicit and implicit personalization

(76) Inventors: Richter A. Rafey, Santa Clara, CA (US); Klaus Hofrichter, Santa Clara, CA (US); Monika Baraniuk, Sunnyvale, CA (US); Jerrold Godes, Brookdale, CA (US); David Wilson, Los Altos, CA (US)

Correspondence Address: Maria McCormack Sobrino, Esq., BLAKELY, SOKOLOFF, TAYLOR & ZAFMAN LLP, Seventh Floor, 12400 Wilshire Boulevard, Los Angeles, CA, 90025-1026, US

(21) Appl. No.: 09/981,776

(22) Filed: Oct. 16, 2001

(51) Int. Cl. G06F 15/173

(52) U.S. Cl. 709/225; 709/221

(57) ABSTRACT

A method for providing personalized use of a device. A usage profile, reflective of preferences of a client can be implicitly and/or explicitly updated to generate a refined profile. The profile may then be used to control usage of a corresponding device.

### FIELD OF THE INVENTION

The invention relates generally to the provision of personalized service into the home environment. More particularly the invention relates to the provision of personalized service by both implicit and explicit means.

### BACKGROUND

Personalization is currently a significant area of exploration in technology fields because targeted content is a major goal of new interactive services. Personalization is typically based on a user profile that maintains a set of preferences on some non-volatile storage, either on a local device or on a remote server. Traditionally personalization is based on explicit information provided by a user. For example, this information is often provided at the time of registration for a service.

Implicit personalization (where a system infers preferences based on usage patterns) is beginning to surface in more commercial products and services, such as the Amazon.com™ (Amazon.com™ is a trademark of Amazon.com™, Inc.) web site and the TiVO™ (TiVO™ is a registered trademark of TiVo, Inc.) personal video recorder (PVR). Amazon.com™ bases its system on a user's purchase history and a database of descriptive information. TiVO™ combines information provided through a “thumbs up/down” feedback system on a remote control with descriptive information about programs (e.g., subject, actors, theme) from an Electronic Program Guide to assume a user's areas of interest. This information is used in recommending similar content. TiVo's implicit personalization also includes automatically adding a “thumbs up” on programs that users select to record manually. This is analogous to Amazon's registering of a users' purchase preferences.

Explicit personalization is more precise and thus typically generates a more accurate user profile. Implicit personalization is arguably more convenient, as it is almost passive on the part of the user (pressing a button on the remote is quite close to passive). Implicit personalization also adapts better to changing preferences over time, because users are unlikely to actively modify their profiles once they have set them up.

The problem with explicit personalization include (1) that it can be very time consuming to specify every possibility, and (2) that it is typically only done once and then ignored. The main problem with implicitly specified profiles is that there is rarely any way to fine-tune the conclusions that are drawn, and thus the content that the system chooses based on the developed preferences may conflict with the user's true interests.

### SUMMARY OF THE INVENTION

A method for providing personalized use of a device. A usage profile, reflective of preferences of a client can be implicitly and/or explicitly updated to generate a refined profile. The profile may then be used to control usage of a corresponding device.

### BRIEF DESCRIPTION OF THE DRAWINGS

The present invention is illustrated by way of example and not limitation in the figures of the accompanying drawings, in which like references indicate similar elements and in which:

FIG. 1 shows one embodiment of the system architecture of the present invention.

FIG. 2 depicts an exemplary processing system in which the present invention may be implemented.

FIG. 3 shows one embodiment of a profile refining process.

FIG. 4 shows one embodiment of exemplary functionalities encompassed by the profile manager.

### DETAILED DESCRIPTION

A model for personalized profiles in interactive systems is disclosed. This model supports both explicit and implicit personalization. There is a common underlying model for the user such that the impact of implicit selections is clear and can be explicitly modified. This enables a more intuitive mental model for the user that facilitates optimal personalization.

The system combines the two methods of specifying preferences. In one embodiment, there is a common underlying model that is exposed to the viewer through an intuitive interface, such as involving hierarchical navigation of the user profile. For example, the underlying user profile may consist of numerous keywords organized in a database, with each entry maintaining a tally of positive or negative feedback for each keyword.

By providing to the user the underlying user profile in the specification stage, possibly on the target device, or even potentially through a Web-based application, the explicit, i.e. user controlled, specification enables the refinement of the profile. The viewer could view preferences by a variety of criteria (e.g., genre, directors, actors) and explicitly increase or decrease the tally of interest for specific keywords. By coupling the two mechanisms with the same underlying database (for example, a database containing structured keywords and interest tallies), a flexible way for a user to develop and refine a profile is enabled. In particular, by allowing the user to use the two methods interchangeably, either approach can serve to fine tune preferences developed the other way. For instance, if a user relies on explicit personalization as a starting point, implicit personalization may serve to further refine the profile without having to revisit it. If the user relies on implicit personalization at first, the user can fine-tune the profile using explicit personalization. For example, when implicitly generated selections start to stray from the user's actual preferences, the user may use explicit personalization to refine the user's profile. Of course, in alternate embodiments, explicit and implicit personalization processes may be performed a variety of times in different sequences to fine tune user preferences.

This interchangeability enhances the quality of the personalization, and provide better information to the user about the effect of specifying preferences. The combined use of explicit and implicit personalization ultimately provides a better connection between the user and the service. It also enables the user to specify preferences by either method, with the described benefits and with a solution for the described shortcomings.

Other features and advantages of the present invention will be apparent from the accompanying drawings and from the detailed description that follows below.

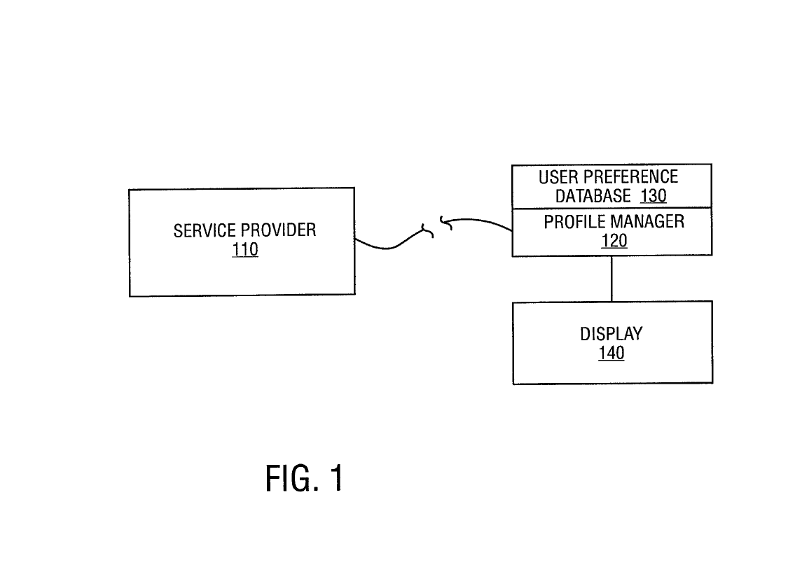

FIG. 1 illustrates one embodiment of the present invention and includes service provider 110, profile manager 120, user preference database 130, and display 140. The service provider 110 provides programming content. In one embodiment, the service provider provides content descriptive data or program data, such as metadata and the like, over the audio/video media (e.g., broadband, cable, satellite) or through a stream separate from the audio/video (e.g., transmitting audio/video content across cable and programming data across the Internet).

The embodiment described herein contemplates the provision of audio and video services by service provider 110. However, the present invention may be applicable to other services, media and apparatus, which can be adapted or configured.

In one embodiment, the profile manager 120 monitors the user's usage pattern of the service and maintains a user profile and uses the profile to provide the service. In one embodiment, the profile manager 120 creates a user profile based upon the user's usage pattern, stores the profile in a user preference database 130 and subsequently references the user profile to determine received content to be presented on the display 140.

In one embodiment, the user preference database 130 may contain multiple user profiles. The database 130 may be located at the service provider or at a user location (e.g. in a set top box or similar controller) for the display 140. The profile manager 120 may be implemented as part of a television set top box, the television receiver or at the service provider.

In one embodiment, the user profile maintained by the profile manager 120 is used to control, for example, filter, program content to provide personalized program content consistent with the user profile. For example, programming content not suitable for any of the system's users is not accepted or used. Only content that matches a user profile active for the current presentation session will be considered for presentation. The personalized program content is transmitted to display 140 for viewing.

In one embodiment, the user is able to explicitly refine the profiles implicitly developed by profile manager 120. In one embodiment, this may be accomplished by providing a current user profile for review and modification by the user whenever the user wishes to modify the profile, including during the specification stage. Similarly, the user may explicitly create a profile using selected available criteria.

As noted above, the user profile may be displayed on the device or other logically or physically coupled devices such as a computing device executing a web-based application coupled to the profile manager 120 directly or indirectly through a network. In one embodiment, the viewer may view preferences by a variety of criteria (e.g., genre, directors, actors) and explicitly increase or decrease a recorded tally of interest for specific key words associated with the criteria. In alternate embodiments, other types of information, such as descriptive information found in metadata, can reflect the preferences of a user and can be modified accordingly.

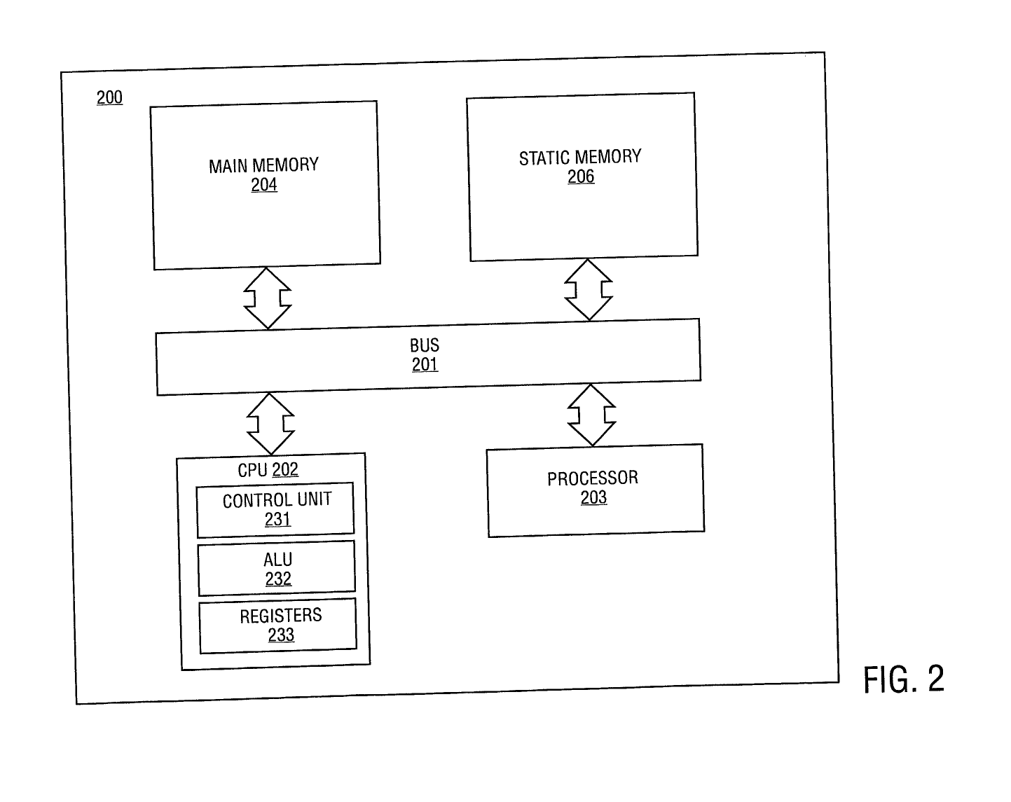

FIG. 2 depicts an exemplary processing system 200 in which the present invention may be implemented. In one embodiment, instructions may be executed using a general processing architecture. Referring to FIG. 2, the processing system may include a bus 201 or other communications means for communicating information, and a central processing unit (CPU) 202 coupled to the bus for processing information. CPU 202 includes a control unit 231, an arithmetic logic unit (ALU) 232, and registers 233. CPU 202 can be used to implement the processes described herein. Furthermore, another processor 203, such as, for example a coprocessor, may be coupled to the bus 201 for additional processing power and speed.

The processing system 200 may also include a main memory, which may be random access memory (RAM) device, that is coupled to the bus 201. The main memory stores information and instructions to be executed by CPU 202. Main memory 204 may also store temporary variables and other intermediate information during the execution of instructions by CPU 202. The processing system also includes a static memory 206, for example a read only memory (ROM) and/or other static device, that is coupled to the bus for storing static information and instructions for CPU 202.

In addition, the methods as described above can be stored in memory of a computer system as a set of instructions to be executed. The instructions to perform the methods as described above could alternatively be stored on other forms of computer-readable mediums, including magnetic and optical disks. For example, the method of the present invention can be stored on computer-readable mediums, such as magnetic disks or optical disks that are accessible via a disk drive (or computer-readable medium drive). It is contemplated that the instructions and data may be locally or remotely stored on a storage media, such as a device coupled to a network. Furthermore all or parts of a program may be stored in one or more local or remote locations.

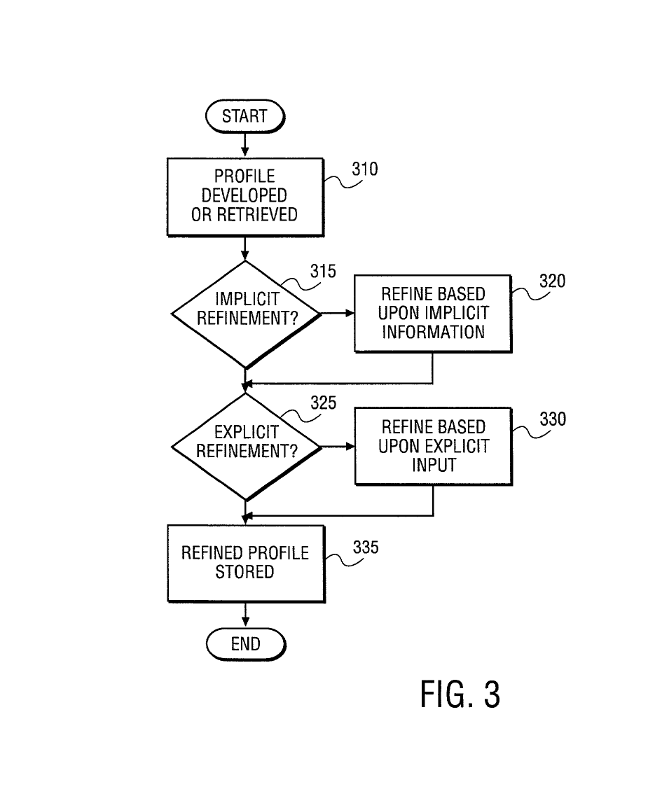

One embodiment of a profile refining process is illustrated in FIG. 3. At step 310, a profile is developed or retrieved. As noted above, a variety of methods may be used to create a profile, including implicit and explicit creation of a profile which can be further modified implicitly and/or explicitly. If a profile already exists, the profile is retrieved for subsequent processing.

At step 315 if the profile is to be implicitly refined, the implicit refinement processes 320, such as ones based upon a user's past usage patterns, are utilized to refine the profile. For example, if the service is the provision of television viewing, and the user has been watching a lot of football recently, the profile may be refined to focus on more football viewing. The selection of implicit refinement may be automatic or selectable by the user.

At step 325, if explicit refinement is chosen, the user is able to explicitly refines his profile, step 330. In one embodiment, the current profile is displayed and the user is able to modify profile elements. By combining implicit and explicit profile refining processes, the system facilitates not only the development but the refinement of a user's profile by the user himself.

At step 335, the refined profile is stored for later refinement of use by the system for providing services or access by the user. In an exemplary embodiment, the stored profile is available for retrieval whenever the user associated with the profile accesses the system, for example the service. Programming consistent with the profile is provided to the user.

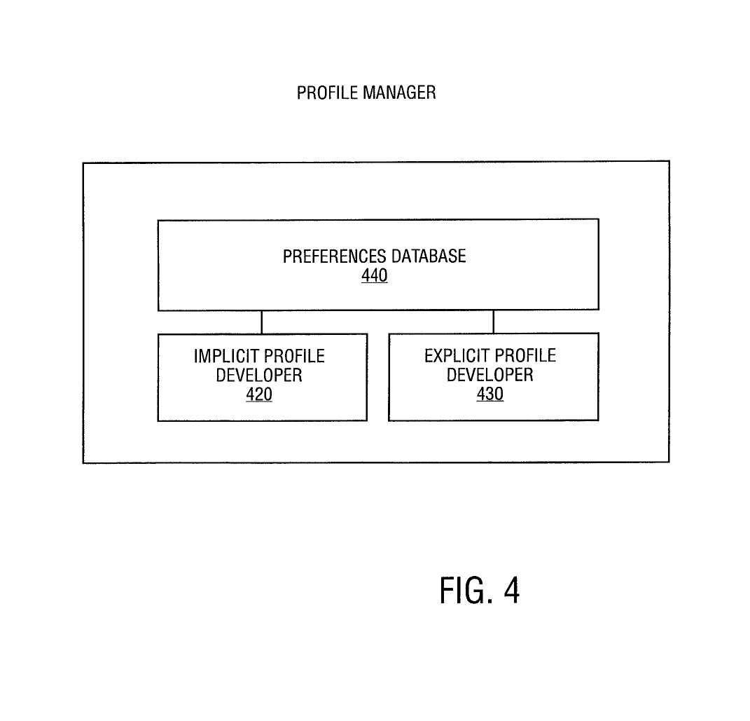

FIG. 4 shows one embodiment of exemplary functionalities encompassed by the profile manager. FIG. 4 shows implicit profile developer 420, preferences database 440, and explicit profile developer 430.

The implicit profile developer 420 develops and selectively modifies user profiles for each user of the system based upon usage by users. This function may be done automatically, e.g. whenever a user accesses the system or selectively, e.g. as indicatd by the user. These profiles are used to determine the programming content to be presented.

Explicit profile developer 430 enables explicit indication of user preferences for user profiles. In one embodiment, the developer 430 enables the creation of explicit user profiles. Alternately and additionally the developer 430 enables the refinement of user profiles. The user profiles refined may be profiles explicitly or implicitly generated or earlier refined. This mechanism facilitates a user creation or modification of a user profile. Conventional means (wired, wireless, optical etc.) may be employed to transmit a users manually selected preferences. The profile mechanisms 420, 430 may be used repetitively to tune a profile to the user's interest.

Preferences database 440 stores the preferences that are developed implicitly and explicitly. These preferences may be retrieved and used to determine the programming content that is eventually presented. As noted earlier, on or more of the elements 420, 430, 440 may be located locally or remotely to each other.

In the foregoing specification, the invention has been described with reference to specific exemplary embodiments thereof. It will however, be evident that various modifications and changes may be made thereto without departing from the broader spirit and scope of the invention as set forth in the appended claims. The specification and drawings are, accordingly to be regarded in an illustrative rather than a restrictive sense.

[image]

[image]

What is claimed is:

1. A method for providing personalized usage of a device:
providing a usage profile; and
refining using at least one of, explicit refinement or implicit refinement to generate a refined profile;
wherein the refined profile may be used to control usage of a corresponding device.

2. The method of claim 1, wherein implicit refinement comprises refining the usage profile according to a user's usage patterns of the corresponding device.

3. The method as set forth in claim 1, wherein explicit refinement comprises enabling a user to modify the profile.

4. The method of claim 1, wherein explicit refinement comprises displaying using a web-based application to display the profile and enabling the user to modify the profile using the web-based application.

5. The method as set forth in claim 1, further comprising storing the refined profile.

6. The method as set forth in claim 1, further comprising further refining a refined profile by at least one process selected from the group consisting of explicitly refining and implicitly refining.

7. A method for providing customized usage of a device comprising:
a user generating a user generated profile of user preferences; and
implicitly refining the user generated profile based on the user's usage patterns of a corresponding device.

8. The method as set forth in claim 7, further comprising further refining usage of a device selected from the group consisting of implicitly refining and explicitly refining, said explicitly refining comprising the user modifying the profile.

9. Machine readable media that provide instructions which when executed by a machine causes the machine to perform operations comprising:
providing a usage profile; and
refining using at least one of explicit refinement or implicit refinement to generate a refined profile;
wherein the refined profile may be used to control usage of a corresponding device.

10. The media as set forth in claim 9, further comprising further refining a refined profile by a process selected from the group consisting of explicitly refining and implicitly refining.

11. The media as set forth in claim 9, wherein implicit refinement comprises refining the usage profile according to a user's usage patterns of the corresponding device.

12. The media as set forth in claim 9, wherein explicit refinement comprises enabling a user to modify the profile with direct visual feedback.

13. An apparatus comprising:
a preference database configured to store user preferences with respect to operation of at least one device;
an implicit profile developer configured to implicitly generate and refine user preferences based upon a user's usage pattern of the at least one device; and
an explicit profile developer configured to enable a user to explicitly modify the user preferences to generate and refine a profile;
wherein the refined profile is used in the operation of the at least one device.

14. The apparatus as set forth in claim 13, wherein the apparatus is located one of local to, remote to or within the device.

15. The apparatus as set forth in claim 13, wherein the apparatus is located remotely at a service provider, the service provider coupled to the device.

16. The apparatus as set forth in claim 13, wherein the explicit profile developer comprises a coupled web-system configured to enable a user to modify user preferences through the world-wide-web.

17. The apparatus as set forth in claim 13, wherein the preferences database comprises specific criteria and a tally of interest for each criterion for at least one user.

18. The apparatus as set forth in claim 13, wherein the implicit profile developer is an automated system triggered by a user's usage of the at least one device.
